(19) United States
(12) Patent Application Publication
(10) Pub. No.: US 2026/0221761 A1
(43) Pub. Date: Jul. 30, 2026

(54) TEMPERATURE-DEPENDENT CURRENT CONTROL SYSTEM FOR HIGH CAPACITANCE LOAD PROTECTION

(71) Applicant: STMicroelectronics International N.V., Geneva (CH)

(72) Inventors: Federica Caponnetto, Gravina di Catania (IT); Salvatore Abbisso, Augusta (SR) (IT); Nicola Errico, Milano (IT); Giovanni Luca Torrisi, Catania (IT)

(21) Appl. No.: 19/039,248

(22) Filed: Jan. 28, 2025

(51) Int. Cl. H02H 9/02

(52) U.S. Cl. CPC H02H 9/02

(57) ABSTRACT

According to an embodiment, a power protector circuit protects a power channel supplying power to an external circuit. The power protector circuit includes a current limiting circuit that operates in a current limitation mode with a first current limit during regular operation and an enhanced current handling mode with a second current limit higher than the first current limit during a power-up operation. A control circuit activates the enhanced current handling mode, ramps up an output current to the second current limit, ramps down the output current to zero, initiates an auto-retry mechanism for multiple attempts to charge an external capacitance, and latches off the power channel if a maximum number of retry attempts is reached. The power protector circuit may be coupled between an electronic control unit and a camera circuit in a vehicle to manage power delivery and protect against fault conditions.

### TECHNICAL FIELD

The present disclosure generally relates to electronic systems and, in particular embodiments, to temperature-dependent current control circuits for protecting decentralized high capacitance loads.

### BACKGROUND

Vehicle manufacturers continue expanding camera system integration to enhance safety and driver assistance capabilities. Modern vehicles, particularly high-end models, may incorporate multiple cameras to support comprehensive monitoring and control functions. These camera systems enable park assist, maneuvering support, collision avoidance, traffic detection, lane change assistance, night vision capabilities, and the like.

Advanced driver assistance systems (ADAS) and autonomous driving applications drive increased camera adoption, particularly for exterior monitoring and surround view functions. Interior cameras further enhance safety by monitoring driver behavior and detecting potential incapacitation. Vehicle control systems utilize the cameras to maintain comprehensive 360-degree environmental awareness, enabling improved response to surrounding conditions.

Generally, camera system implementation relies on decentralized electronic components operating from central control units at various distances. The systems typically employ coaxial cables for power delivery and signal transmission between a central electronic control unit (ECU) and remote camera devices around the vehicle.

Remote camera devices incorporate substantial input capacitance, ranging from tens to hundreds of microfarads, to maintain power supply stability and filtering. This high capacitance creates a significant inrush current during power-up sequences, requiring careful power delivery management.

### SUMMARY

Technical advantages are generally achieved by embodiments of this disclosure, which describe temperature-dependent current control circuits for protecting decentralized high capacitance loads.

A first aspect relates to a method for controlling current in a power protector circuit that protects a power channel supplying power to an external circuit, the method comprising activating an enhanced current handling mode for the power protector circuit during a power-up operation, the power protector circuit having a current limitation mode with a first current limit during regular operation, the enhanced current handling mode having a second current limit higher than the first current limit; ramping up an output current from zero to the second current limit over a first predetermined period; ramping down the output current from the second current limit to zero over a second predetermined period; and initiating an auto-retry mechanism allowing for multiple attempts to charge an external capacitance of the external circuit using the enhanced current handling mode, wherein each attempt includes the ramping up and ramping down.

A second aspect relates to a power protector circuit for protecting a power channel supplying power to an external circuit, the power protector circuit comprising a power input terminal; at least one power output terminal; a current limiting circuit coupled between the power input terminal and the power output terminal, the current limiting circuit configured to operate in a current limitation mode with a first current limit during regular operation, and operate in an enhanced current handling mode with a second current limit higher than the first current limit during a power-up operation; and a control circuit configured to activate the enhanced current handling mode during the power-up operation, ramp up an output current from zero to the second current limit over a first predetermined period, ramp down the output current from the second current limit to zero over a second predetermined period, initiate an auto-retry mechanism that allows for multiple attempts to charge an external capacitance of the external circuit using the enhanced current handling mode, wherein each attempt includes the ramping up and ramping down, and latch off the power channel to prevent further charging attempts until a fault condition is cleared or the power protector circuit is reset in response to determining that a maximum number of retry attempts has been reached.

A third aspect relates to a system comprising an electronic control unit (ECU); a camera circuit; and a power protector circuit coupled between the ECU and the camera circuit for protecting a power channel supplying power to the camera circuit, the power protector circuit comprising a current limiting circuit configured to operate in a current limitation mode with a first current limit during regular operation and an enhanced current handling mode with a second current limit higher than the first current limit during a power-up operation; and a control circuit configured to activate the enhanced current handling mode during the power-up operation, ramp up an output current from zero to the second current limit over a first predetermined period, ramp down the output current from the second current limit to zero over a second predetermined period, initiate an auto-retry mechanism that allows for multiple attempts to charge a capacitance of the camera circuit using the enhanced current handling mode, and latch off the power channel to prevent further charging attempts until a fault condition is cleared or the power protector circuit is reset in response to determining that a maximum number of retry attempts has been reached.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of an embodiment camera system;

FIG. 2 is a block diagram of an electronic control unit (ECU);

FIG. 3 is a block diagram of an embodiment power protector circuit;

FIG. 4 is a flowchart of an embodiment method for operating a power protector circuit;

FIG. 5 is an embodiment timing diagram comparing the operation of the power protector circuit in charge mode and standard current limitation mode; and

FIG. 6 is an embodiment diagram depicting the temperature-dependent adjustment of the elevated current limitation (I_{CM}) value in the power protector circuit.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of automotive camera systems, it should also be appreciated that they may also apply to any decentralized electronic system incorporating high capacitance loads requiring power protection. In particular, aspects of this disclosure may apply to applications adopting power protector devices to feed de-centralized or satellite off-board ECU modules. Such applications can include industrial control systems, remote sensor networks, distributed lighting systems, or any configuration where remote loads with significant input capacitance are powered through extended cable connections and require power protection functionality.

Aspects of the disclosure relate to a power protection system that implements an enhanced current handling capability for charging high capacitance loads. In embodiments, during power-up sequences, the system temporarily increases current limitation thresholds to facilitate faster capacitor charging while maintaining fault protection. The current limiting circuit operates with a standard current limitation (I_{LIM}) during regular operation. It implements an elevated current limitation (I_{CM}) during the charge-mode operation, where the elevated current limitation (I_{CM}) can be twice the standard current limitation (I_{LIM}) value.

In embodiments, a temperature-dependent control system dynamically adjusts the charge-mode current limitation based on junction temperature measurements. The system can implement a linear reduction in the elevated current limitation (I_{CM}) value as temperature increases, eventually matching the standard current limitation (I_{LIM}) value at maximum junction temperature (e.g., 175°C). The temperature-dependent adjustment can prevent thermal shutdown while maintaining enhanced charging capabilities at lower temperatures.

In embodiments, the system implements an auto-retry mechanism that monitors charging cycles during the charge-mode operation. The mechanism can allow multiple charging attempts (e.g., eight charging attempts), with each attempt including a defined charge-mode period followed by a cool-down interval. If capacitor charging cannot be completed within the specified number of cycles, the system can identify a potential fault condition, such as a short to ground. The number of retry attempts and timing parameters may be configured based on specific application requirements.

In embodiments, an analog-to-digital converter (ADC) monitors input voltage, output voltage, and current flow through the power protector circuit. The monitoring can enable the detection of successful capacitor charging and fault conditions. A dedicated enable pin can allow selective activation of the charge-mode operation, and status registers can be used to maintain information about operating states and fault conditions.

As used throughout this disclosure, the term "camera system" encompasses not only visual imaging devices but also other sensing devices including, but not limited to, radar sensors, lidar (Light Detection and Ranging) sensors, infrared sensors, ultrasonic sensors, or any combination thereof. The power protection aspects described herein may apply to any such sensing devices that incorporate high capacitance loads and receive power through extended cable connections. References to camera circuits, camera modules, or camera systems throughout this disclosure should be interpreted to include any of these sensing technologies.

In embodiments, the power protection system includes a microcontroller interface for configuration and monitoring. Through the interface, the system can report charging status, fault conditions, and temperature measurements. The system may be implemented in various applications where remote loads with high input capacitance (hundreds of microfarads) receive power through extended cable connections, such as automotive camera modules, industrial sensors, or other decentralized electronic systems. These and additional details are discussed below.

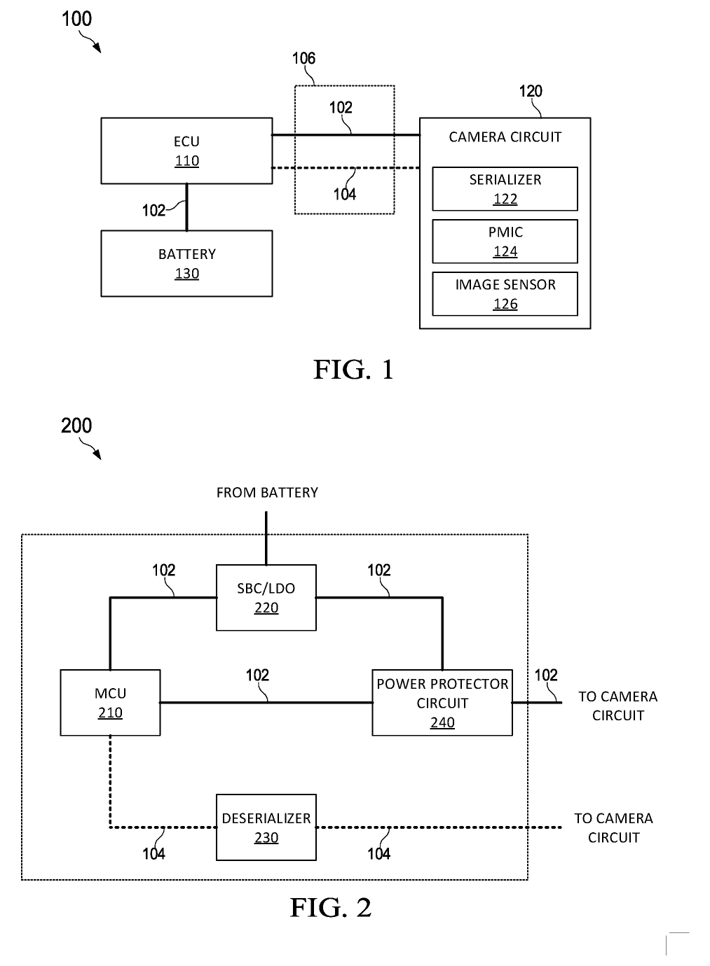

FIG. 1 illustrates a block diagram of an embodiment camera system 100. The camera system 100 includes an electronic control unit (ECU) 110 coupled to a camera circuit 120 through power line 102 and signal line 104. A battery 130 couples to the ECU 110 to provide system power. The power line 102 and signal line 104 may be implemented through a coaxial cable 106, enabling both power delivery and data transmission between the ECU 110 and camera circuit 120.

The ECU 110 monitors operating conditions, including temperature, which affects the performance of semiconductor devices in power protector circuits. The power protector circuits implement current limiting and temperature-dependent control to safely manage power delivery to camera circuit 120 while maintaining system protection. The ECU 110 can monitor voltage and current conditions through the power line 102 to detect successful capacitor charging or potential fault conditions. In embodiments, the power protector circuit includes temperature sensors.

In embodiments, the camera circuit 120 includes a serializer 122, a power management integrated circuit (PMIC) 124, and an image sensor 126. The serializer 122 is configured to convert parallel data from the image sensor 126 into serial data for transmission through signal line 104 to the ECU 110. The PMIC 124 manages and regulates power received through power line 102 to provide appropriate voltage levels to the image sensor 126 and serializer 122.

The PMIC 124 incorporates input capacitance ranging from tens to hundreds of microfarads for power supply filtering and stability. The high capacitance creates significant inrush current demands during power-up sequences. The ECU 110 includes power protector circuitry to manage the inrush currents while protecting against potential fault conditions such as short circuits to ground or battery.

The image sensor 126 captures optical information and converts it to electrical signals for processing. In some embodiments, the image sensor 126 may include a radar sensor, lidar sensor, infrared sensor, or ultrasonic sensor instead of or in addition to an optical sensor. The serializer 122, PMIC 124, and image sensor 126 operate as a decentralized sensing system that receives power and exchanges data with the ECU 110 through the coaxial cable 106.

In embodiments, a coaxial cable 106 implementation allows for Power-over-Coaxial (PoC) operation, where a single cable carries power and data signals between the ECU 110 and the remote camera circuit 120. The configuration supports decentralized placement of camera circuit 120 at various locations around a vehicle while minimizing wiring complexity. Multiples of the camera circuit 120 may be implemented in a vehicle, with each camera circuit 120 requiring its dedicated power protection and coaxial cable 106 connection to the ECU 110.

Although FIG. 1 illustrates a single camera circuit coupled to the ECU 110, it should be understood that in other embodiments, the camera system 100 may include multiple camera circuits 120 positioned at different locations. Each camera circuit 120 may couple to the ECU 110 through separate coaxial cables, with each coaxial cable 106 carrying power line 102 and signal line 104 connections. The ECU 110 can manage power delivery and data communication with multiple camera circuits 120 simultaneously, with each camera circuit 120 potentially serving different sensing functions such as park assist, surround view monitoring, or driver monitoring. The power protection and temperature-dependent current control aspects described herein may apply to each camera circuit 120 connection.

FIG. 2 illustrates a block diagram of an electronic control unit (ECU) 200, which may be implemented as the ECU 110 shown in FIG. 1. The ECU 200 includes a system basis chip/low dropout regulator (SBC/LDO) 220 that receives power from a battery and distributes regulated power through power lines 102 to other components within the ECU 200.

A microcontroller (MCU) 210 couples to the SBC/LDO 220 and a power protector circuit 240 through power lines 102. The power protector circuit 240 manages power delivery to external camera circuits through power lines 102.

In embodiments, MCU 210 manages overall system operation and interfaces with multiple components within the ECU 200. Through power lines 102, the MCU 210 receives regulated power from the SBC/LDO 220. The MCU 210 communicates with the power protector circuit 240 to configure operating parameters and monitor power delivery conditions to the camera circuit 120.

During power-up sequences, the MCU 210 can enable charge mode operation in the power protector circuit 240 through a dedicated enable signal. The MCU 210 receives status information from the power protector circuit 240, including voltage measurements, current flow data, temperature readings, and fault conditions through a protocol communication interface. Based on the measurements, the MCU 210 can determine successful capacitor charging or detect potential fault conditions, such as short circuits.

In embodiments, MCU 210 interfaces with the deserializer 230 through signal lines 104 to manage data communication with camera circuit 120. The MCU 210 processes the deserialized data received from camera circuit 120 and can adjust power protector circuit 240 settings based on camera circuit operating conditions. If multiples of the camera circuit 120 are implemented, the MCU 210 can manage a corresponding power protector circuit 240 and deserializer 230 for each camera circuit 120, coordinating power delivery and data communication across all connected devices.

In embodiments, MCU 210 implements protection timing and retry attempt counting during charge mode operation. After a specific number of retry attempts, the MCU 210 can disable charge mode operation and implement appropriate fault handling procedures. The MCU 210 can maintain system status information and adjust current limitation thresholds based on temperature measurements to optimize system performance while maintaining protection.

A deserializer 230 couples to the MCU 210 through signal lines 104 and handles data communication with external camera circuits. In embodiments, the deserializer 230 converts serialized data received from camera circuits into parallel data for processing by the MCU 210.

In embodiments, the power protector circuit 240 implements temperature-dependent current control for managing high capacitance loads in the camera circuits. During power-up sequences, the power protector circuit 240 can operate in a charge mode with elevated current limits to facilitate faster capacitor charging. The MCU 210 can monitor operating conditions through the power protector circuit 240, including voltage levels, current flow, and temperature measurements, to manage charging cycles and detect potential fault conditions.

Power protector circuit 240 may be implemented using Bipolar-Complementary Metal Oxide Semiconductor-Double Diffused Metal Oxide Semiconductor (BCD) technology, which integrates bipolar, complementary metal oxide semiconductor (CMOS), and double-diffused metal oxide semiconductor (DMOS) devices on a single chip.

In lateral flow implementations, current flows horizontally across the semiconductor surface rather than vertically through the device. Such lateral current flow architectures can affect thermal dissipation capabilities and current handling characteristics of the power protector circuit, particularly as operating temperatures increase. The thermal characteristics of lateral flow devices can influence maximum current handling capabilities during high-current operations such as capacitor charging sequences.

Existing power protection solutions implement soft-start procedures to manage inrush current during power-up sequences. These solutions ramp output current from zero to a fixed current limitation threshold (I_{LIM}) over a defined soft-start period. During the power-up phase, each output operates as a current source, with the switches maintaining current limitation, resulting in high power dissipation across the field effect transistors (FETs).

To prevent damage from extended high-power dissipation, the FETs can remain in their current limitation for only a specific duration (time). When the duration expires, the switches turn off to protect the FETs from excessive power dissipation. After a fixed cool-down period, the system re-enables the channel, initiating another soft-start sequence.

Significant current spikes can occur during turn-on in applications with large input capacitance, such as camera circuits with hundreds of microfarads of filtering capacitance. The fixed current limitation in existing solutions may trigger during these inrush current events, causing the high-side switches to turn off before the capacitors achieve proper charging levels. The premature switch deactivation prevents proper initialization of remote camera circuits.

In these solutions, the cycle of current limitation, switch deactivation, and restart attempts continue indefinitely until the input capacitors eventually charge or a fault condition is declared. The cycling behavior extends the total power-up time and may prevent the successful activation of remote camera circuits. Additionally, the fixed current limitation threshold does not account for temperature variations that affect FET current handling capability, potentially leading to thermal shutdown during repeated charging attempts. Embodiments of this disclosure overcome the deficiencies in the existing solutions.

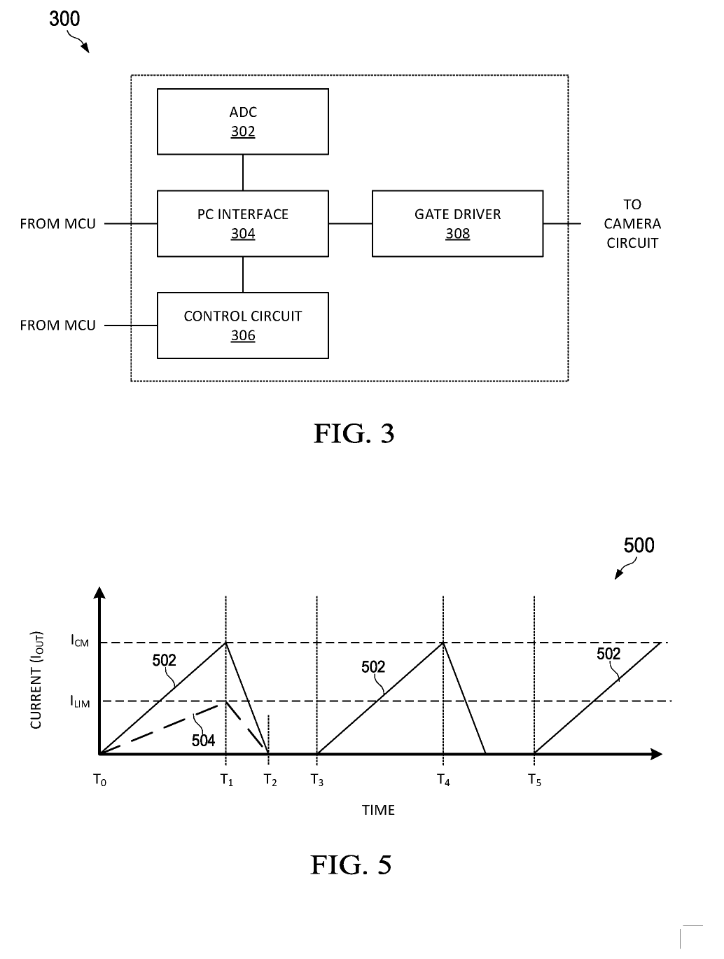

FIG. 3 illustrates a block diagram of an embodiment power protector circuit 300, which can be implemented as the power protector circuit 240 of FIG. 2. Power protector circuit 300 includes an analog-to-digital converter (ADC) 302, a protocol communication (PC) interface 304, a control circuit 306, and a gate driver 308, which may (or may not) be arranged as shown. Power protector circuit 300 may include additional components that are not shown, such as one or more temperature sensors.

In embodiments, ADC 302 couples to the input and output terminals of the power protector circuit 300. The ADC 302 is configured to monitor input voltage, output voltage, and current flow. The measurements enable the detection of successful capacitor charging and fault conditions. A dedicated enable pin can allow selective activation of charge mode operation, while status registers can maintain information about operating states and fault conditions. The power protector circuit 300 interfaces with the MCU 210 for configuration and status reporting.

The protocol communication (PC) interface 304 couples to the MCU 210 and facilitates configuration and status reporting. Through protocol communication (PC) interface 304, the MCU 210 can configure operating parameters such as current limitation thresholds, charge mode settings, and retry attempt counts. Protocol communication (PC) interface 304 can allow the MCU 210 to read status information, such as fault conditions, temperature measurements, and operating states. In embodiments, the protocol communication (PC) interface 304 includes a temperature sensing circuit, a current limiting circuit, a dedicated input pin for enabling the enhanced current handling mode, a status register for indicating an operational state of the current limiting circuit, or a combination thereof.

In embodiments, the control circuit 306 implements the temperature-dependent current control functionality. During charge mode operation, the control circuit 306 can adjust current limitation thresholds based on temperature measurements, manage retry attempts, and control mode transitions. The control circuit 306 can maintain status registers and implement protection timing for fault conditions.

In embodiments, gate driver 308 couples to back-to-back switches that control the power delivery to the camera circuit 120. Based on signals from the control circuit 306, the gate driver 308 controls the switches to implement current limiting, fault protection, and charge mode operation. During charge mode, gate driver 308 manages the ramping of output current according to the temperature-adjusted current limitation thresholds.

The power protector circuit 300 is configured to control and manage power delivery to external loads. The power protector circuit 300 includes protection features for multiple fault conditions, such as short-to-battery protection, short-to-ground protection, and overcurrent protection at each output. During regular operation, the power protector circuit 300 implements a standard current limitation (I_{LIM}) to protect against overcurrent conditions.

The power protector circuit 300 can incorporate back-to-back switches that can disconnect power delivery upon detection of fault conditions. For short-to-battery protection, the switches open to isolate the protected load from excessive voltage. For short-to-ground protection, the switches prevent excessive current flow to ground. The overcurrent protection can monitor current flow and trigger the switches to open if the current exceeds defined thresholds.

Environmental conditions in automotive applications can lead to significant temperature variations affecting semiconductor device operation. As junction temperatures increase, semiconductor current handling capabilities decrease, impacting power protector circuit performance. The charging time for input capacitors varies based on capacitance value, supply voltage level, and current limit thresholds while considering these temperature effects.

During initial power-up sequences, the power protector circuit 300 can implement an enhanced charge mode where the current limitation threshold (I_{LIMTH}) temporarily increases to facilitate faster charging of high capacitance loads. The current charge mode limitation can vary based on operating temperature, with the current limitation threshold (I_{LIMTH}) decreasing linearly as temperature increases until it matches the standard current limitation (I_{LIM}) value at maximum junction temperature. The temperature-dependent control can prevent thermal shutdown while maintaining enhanced charging capabilities at lower temperatures.

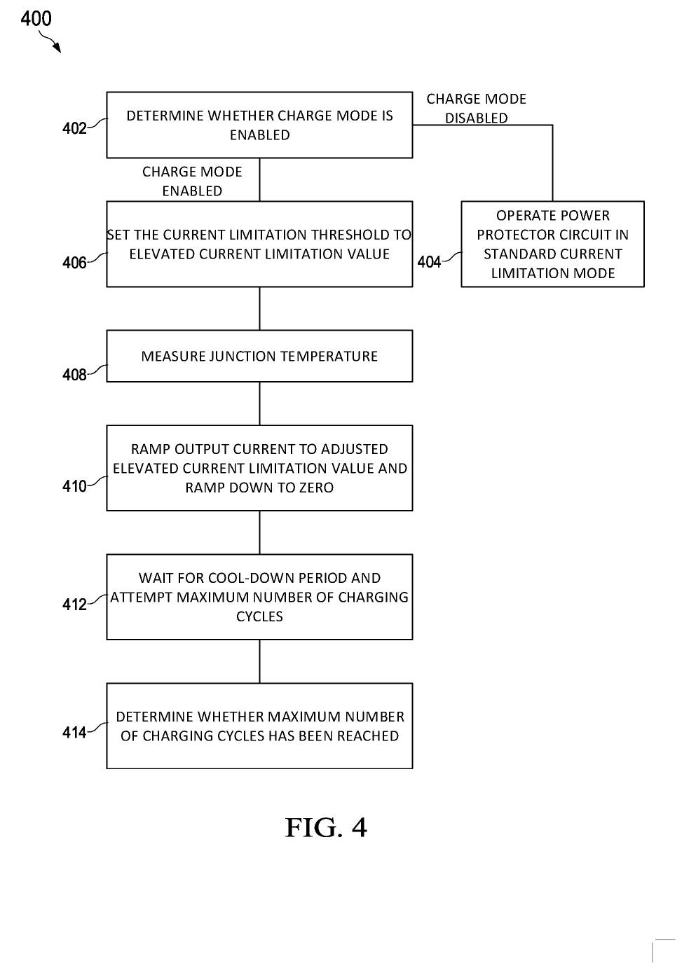

FIG. 4 illustrates a flowchart of an embodiment method 400 for operating a power protector circuit. It is noted that all steps outlined in the flow charts of the method are not necessarily required and can be optional. Further, changes to the arrangement of the steps, removal of one or more steps and path connections, and addition of steps and path connections are similarly contemplated.

At step 402, the power protector circuit determines whether charge mode is enabled. Charge mode may be enabled through a dedicated enable pin or configuration settings received from an MCU via a protocol communication interface. The method transitions to step 406 if charge mode is enabled and to step 404 if charge mode is disabled.

At step 404, if charge mode is disabled, the power protector circuit operates in standard current limitation mode. In this mode, the current limitation threshold is set to a standard current limitation (I_{LIM}) value to protect against overcurrent conditions. A gate driver controls the back-to-back switches to limit output current to the standard current limitation (I_{LIM}) value.

At step 406, if charge mode is enabled, the power protector circuit sets the current limitation threshold to an elevated current limitation (I_{CM}) value. The value of the elevated current limitation (I_{CM}) may be a multiple of the standard current limitation (I_{LIM}) value, such as twice the standard current limitation (I_{LIM}) value, to allow for faster charging of high capacitance loads.

The specific multiple used for the elevated current limitation (I_{CM}) value can be predetermined or configurable based on system requirements and characteristics of the connected load. In some embodiments, the power protector circuit may receive configuration settings from the MCU to set the elevated current limitation (I_{CM}) value. The elevated current limitation (I_{CM}) value is selected to balance faster charging of high capacitance loads with the thermal dissipation capabilities of the power protector circuit and connected components.

At step 408, the power protector circuit measures the junction temperature. In embodiments, the junction temperature is measured using temperature sensors integrated within the device. To provide accurate temperature measurements, the temperature sensors may be strategically located near critical components, such as the back-to-back switches or other power-handling elements.

Based on the measured temperature, the power protector circuit adjusts the elevated current limitation (I_{CM}) value. The adjustment may follow a linear relationship, with the elevated current limitation (I_{CM}) decreasing as temperature increases until reaching the standard current limitation (I_{LIM}) value at a maximum junction temperature, such as 175°C.

The rate of decrease in the elevated current limitation (I_{CM}) value to temperature may be determined based on the thermal characteristics of the power protector circuit and its ability to dissipate heat. By dynamically adjusting the elevated current limitation (I_{CM}) value based on temperature, the power protector circuit can optimize charging performance while preventing thermal overload and potential damage to the device. In embodiments where temperature-dependent adjustment is not required or where simplified operation is desired, step 408 may be optional, and the power protector circuit can operate with a fixed elevated current limitation (I_{CM}) value.

At step 410, the power protector circuit ramps the output current to the adjusted elevated current limitation (I_{CM}) value over a defined period. The ramping process helps minimize stress on the system components by gradually increasing the current flow. The duration of the ramping period may be predetermined or configurable based on the characteristics of the connected load and the desired charging time. A slower ramping rate may be used for loads with higher capacitance values to reduce inrush current and minimize voltage fluctuations. The power protector circuit may use a controlled current source or a pulse-width modulation (PWM) technique to achieve the gradual ramping of the output current.

Once the output current reaches the elevated current limitation (I_{CM}) value, the power protector circuit immediately ramps down the output current to zero over a second defined period. The ramping down process helps prevent abrupt changes in current flow, which could cause voltage spikes or electromagnetic interference (EMI) issues. The duration of the ramping down period may be similar to or shorter than the ramping up period, depending on the system requirements and the connected load's characteristics. The power protector circuit may employ a controlled discharge path or a PWM technique to achieve the gradual ramping down of the output current to zero.

At step 412, the power protector circuit enters a cool-down phase to allow for thermal dissipation before attempting another charging cycle. The cool-down phase helps prevent thermal buildup and potential damage to the power protector circuit and connected components. The duration of the cool-down period may be predetermined or configurable based on the thermal characteristics of the system and the expected heat generation during the charging process. In embodiments, the cool-down period begins when the output current (I_{OUT}) reaches the elevated current limitation (I_{CM}) value and ends when the next ramp-up period begins.

In embodiments, the power protector circuit may use a timer or a countdown mechanism to control the duration of the cool-down period. The timer may be started immediately after the output current reaches zero at the end of the ramping down process. The power protector circuit may monitor the timer value and wait until the specified cool-down duration has elapsed before proceeding to the next charging cycle.

The specific duration of the cool-down period can be adjusted based on factors such as the ambient temperature, the thermal dissipation capabilities of the power protector circuit, and the characteristics of the connected load. In an embodiment, the interval for the cool-down period is set to a default value, such as 2 milliseconds, which provides a balance between allowing sufficient time for thermal dissipation and minimizing the overall charging time.

In embodiments, steps 406 through 412 are repeated for a set number of retry attempts, where during each attempt, the charge cycle is repeated with a temperature-adjusted elevated current limitation (I_{CM}). The number of retry attempts may be predetermined or configurable based on system requirements and the characteristics of the connected load. In embodiments, the number of retry attempts is set to a specific value, such as eight, to provide a reasonable balance between attempting to charge the high capacitance load and preventing excessive retries that may indicate a fault condition.

The power protector circuit may maintain a retry counter to keep track of the number of attempted charging cycles. After each cool-down period, the retry counter is incremented, and the power protector circuit checks whether the maximum number of retry attempts has been reached. If the maximum number of retry attempts has not been reached, the power protector circuit proceeds to step 406 to start another charging cycle with a temperature-adjusted elevated current limitation (I_{CM}). If the maximum number of retry attempts has been reached, the power protector circuit proceeds to step 414 to handle the fault condition.

At step 414, in response to reaching the maximum number of retry attempts, the power protector circuit determines that a fault condition exists and takes appropriate actions to protect the system. The fault condition may indicate a short circuit, an overload condition, or other issues preventing the successful charging of the high capacitance load.

In embodiments, upon detecting the fault condition, the power protector circuit immediately disables the charge mode to prevent further attempts at charging the load. This protects the power protector circuit and the connected components from potential damage from repeated exposure to high current levels. The power protector circuit may set an internal flag or update a status register to indicate that the charge mode has been disabled.

In addition to disabling the charge mode, the power protector circuit can report the fault condition to the MCU through a protocol communication interface. The power protector circuit may send the MCU a specific fault code or status message to indicate the nature of the fault condition. Based on the reported fault condition, the MCU can take appropriate actions, such as notifying the user, logging the event, or initiating a system shutdown or reset.

In embodiments, the power protector circuit utilizes a counter mechanism to keep track of the number of retry attempts. The counter is initialized to zero at the beginning of the charging process and is incremented after each cool-down period. At the beginning of each retry attempt, the power protector circuit compares the counter value to the maximum number of retry attempts. If the counter value exceeds the maximum number of retry attempts, the power protector circuit determines that a fault condition has occurred.

When the maximum number of retry attempts has been reached, the power protector circuit latches off the affected channel to prevent further charging attempts. The latching mechanism ensures the channel remains disabled until the fault condition is cleared or the system is reset. The power protector circuit may implement the latching functionality using a hardware latch or a software flag.

In embodiments, the power protector circuit activates a status register or a specific bit within a status register to indicate that the maximum number of retry attempts has been reached. The MCU can read the status information through the protocol communication interface, allowing the MCU to monitor the status of the charging process and take appropriate actions in case of a fault condition.

The MCU may periodically poll the status register or receive an interrupt when the status register is updated. Based on the status information, the MCU can implement fault-handling routines, such as notifying the user, logging the event, or initiating a system shutdown or reset. The MCU may also attempt to clear the fault condition by sending a reset command to the power protector circuit or cycling the power to the affected channel.

FIG. 5 illustrates an embodiment timing diagram 500 comparing the operation of the power protector circuit in charge mode and standard current limitation mode. The timing diagram 500 shows the output current (I_{OUT}) of the power protector circuit over time.

Plot 502 represents the output current behavior during charge mode operation. In charge mode, the power protector circuit attempts to charge the high capacitance load by ramping up the output current to an elevated current limitation (I_{CM}) value. The elevated current limitation (I_{CM}) is set to a higher value than the standard current limitation (I_{LIM}) to facilitate faster charging of the capacitive load.

As shown in plot 502, the output current ramps up from zero to the elevated current limitation (I_{CM}) value over a defined period (i.e., from time T₀ to time T₁). Once the output current reaches the elevated current limitation (I_{CM}), the power protector circuit immediately ramps down the output current to zero over a second defined period (i.e., from time T₁ to time T₂). Ramping up and down the output current constitutes a single retry attempt.

Plot 502 illustrates multiple retry attempts (e.g., at times T₃and T₅), where each attempt follows the same pattern of ramping up the output current to the elevated current limitation (I_{CM}) and then ramping down to zero. The power protector circuit waits for a cool-down period (i.e., from time T₂ to time T₃) between consecutive retry attempts to allow for thermal dissipation. The number of retry attempts can be set by a configurable parameter, such as a maximum retry count.

During each retry attempt, the elevated current limitation (I_{CM}) value may be adjusted based on the measured temperature of the power protector circuit, as previously discussed. The temperature-dependent adjustment helps optimize the charging process while preventing thermal overload and potential damage to the device.

If the maximum number of retry attempts to charge the capacitive load has been reached without successful completion, the power protector circuit considers this condition a potential short-to-ground fault. A short-to-ground fault occurs when there is an unintended low-resistance path between the output of the power protector circuit and ground, preventing the proper charging of the capacitive load. In this scenario, despite multiple attempts to charge the capacitor using the elevated current limitation (I_{CM}) value, the power protector circuit fails to achieve the desired charging level within the specified retry limit. The persistent failure to charge the capacitor indicates the presence of a fault condition, such as a short circuit to ground, that requires immediate attention to protect the system from potential damage.

In response to reaching the maximum number of retry attempts, the power protector circuit latches off the relevant channel to prevent further charging attempts. The latching mechanism ensures the channel remains disabled until the fault condition is cleared or the system is reset. This latching behavior helps protect the power protector circuit and the connected components from potential damage caused by repeated exposure to high current levels during unsuccessful charging attempts. The power protector circuit may use a hardware latch or a software flag to implement the latching functionality, effectively isolating the affected channel from further charging cycles until the appropriate corrective action is taken.

Plot 504 represents the output current behavior during standard current limitation mode. In this mode, the power protector circuit operates with a fixed current limitation threshold set to the standard current limitation (I_{LIM}) value. When the output current reaches the standard current limitation (I_{LIM}), the power protector circuit takes action to protect against overcurrent conditions.

As shown in plot 504, the output current ramps up from zero to the standard current limitation (I_{LIM}) value over a defined period (i.e., from time T₀ to time T₁). Once the output current reaches the standard current limitation (I_{LIM}), the power protector circuit immediately shuts off the output current to prevent excessive current flow. This shutoff behavior is indicated by the abrupt drop in the output current from the standard current limitation (I_{LIM}) value to zero (i.e., from time T₁to time T₂).

The standard current limitation mode serves as a protective mechanism to safeguard the power protector circuit and the connected components from overcurrent conditions. When the output current reaches the standard current limitation (I_{LIM}) threshold, the power protector circuit quickly intervenes to prevent potential damage by shutting off the current flow.

The specific value of the standard current limitation (I_{LIM}) and the time period (i.e., from time T₀to time T₁) can be configured based on the characteristics of the connected load and the maximum allowable current for safe operation.

The timing diagram 500 highlights the differences between charge mode and standard current limitation mode. Charge mode allows for faster charging of high capacitance loads by employing an elevated current limitation (I_{CM}) and multiple retry attempts. In contrast, standard current limitation mode operates with a fixed current limitation threshold (I_{LIM}).

The specific values of the elevated current limitation (I_{CM}) and the time periods (i.e., between times T₁, T₂, T₃, T₄) can be configured based on the characteristics of the connected load and the thermal dissipation capabilities of the power protector circuit. The timing diagram 500 provides a visual representation of how the power protector circuit adapts its behavior to efficiently charge high capacitance loads while maintaining robust protection against fault conditions.

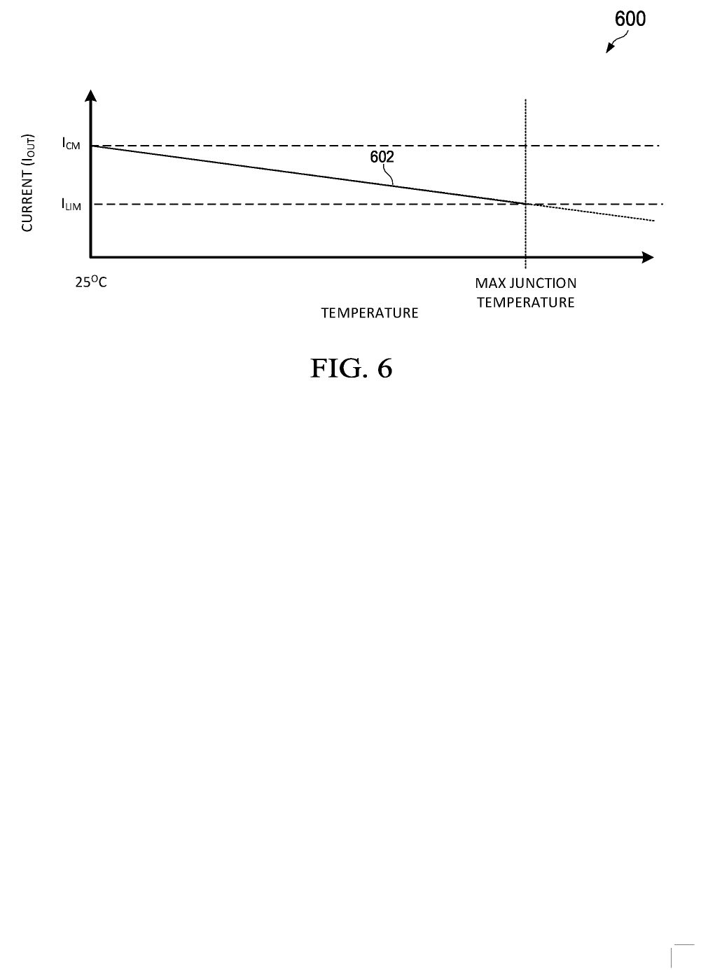

FIG. 6 illustrates an embodiment diagram 600 depicting the temperature-dependent adjustment of the elevated current limitation (I_{CM}) value in the power protector circuit. The diagram 600 shows how the temperature-adjusted elevated current limitation value 602 varies with respect to temperature, starting from an initial value at room temperature (e.g., 25°C) and decreasing linearly until it reaches the standard current limitation (I_{LIM}) value at the maximum junction temperature of the device.

The temperature-adjusted elevated current limitation value 602 is intentionally designed to be temperature-dependent to prevent rapid thermal shutdown of the power protector circuit. In applications involving high capacitance loads, the power protector circuit may experience significant power dissipation during the charging process, especially when operating at elevated current levels.

If the temperature-adjusted elevated current limitation value 602 remains constant regardless of temperature, it could lead to excessive power dissipation and heat generation at higher temperatures, potentially triggering a thermal shutdown event. By making the temperature-adjusted elevated current limitation value 602 temperature-dependent, the power protector circuit can dynamically adjust its current handling capability based on the thermal conditions.

As the temperature increases and approaches the thermal limits of the device, the gradual reduction in the temperature-adjusted elevated current limitation value 602 helps to mitigate the risk of rapid thermal shutdown. This temperature-dependent control mechanism allows the power protector circuit to operate safely and reliably across a wide range of temperature conditions, ensuring optimal charging performance while maintaining thermal stability and preventing sudden interruptions due to thermal protection mechanisms.

At lower temperatures, such as room temperature (25°C), the power protector circuit can support a higher temperature-adjusted elevated current limitation value 602 at the elevated current limitation (I_{CM}) value due to the increased current handling capability of the semiconductor devices and improved thermal dissipation. The higher temperature-adjusted elevated current limitation value 602 allows for faster charging of the high capacitance loads connected to the power protector circuit.

As the temperature of the power protector circuit increases, the temperature-adjusted elevated current limitation value 602 is gradually reduced to ensure safe operation and prevent thermal overload. The rate of decrease in the temperature-adjusted elevated current limitation value 602 can be determined based on the thermal characteristics of the power protector circuit and its ability to dissipate heat effectively.

The linear relationship between the temperature-adjusted elevated current limitation value 602 and temperature can be implemented by a temperature-dependent control system within the power protector circuit. The control system continuously monitors the junction temperature using integrated temperature sensors and adjusts the temperature-adjusted elevated current limitation value 602 accordingly.

At the maximum junction temperature, which is typically specified by the device manufacturer (e.g., 175°C), the temperature-adjusted elevated current limitation value 602 reaches the standard current limitation (I_{LIM}) value. This ensures that the power protector circuit operates within its safe operating limits, even under extreme temperature conditions. By limiting the temperature-adjusted elevated current limitation value 602 to the standard current limitation (I_{LIM}) value at high temperatures, the power protector circuit prevents thermal shutdown and potential damage to the device.

The temperature-dependent adjustment of the temperature-adjusted elevated current limitation value 602 allows the power protector circuit to optimize its current handling capability based on the operating temperature. At lower temperatures, the power protector circuit can leverage the increased current capacity to achieve faster charging of high capacitance loads. As the temperature rises, the gradual reduction in the temperature-adjusted elevated current limitation value 602 ensures that the device remains within its thermal limits, maintaining a balance between charging performance and device protection.

The specific values of the temperature-adjusted elevated current limitation value 602 at room temperature and the maximum junction temperature, as well as the slope of the linear decrease, can be determined based on the electrical and thermal characteristics of the power protector circuit. These values may be configurable or predetermined based on the device specifications and application requirements.

The power protector circuit can optimize its performance across a wide range of operating conditions by dynamically adjusting the temperature-adjusted elevated current limitation value 602 based on the measured temperature. This temperature-dependent control mechanism enhances the reliability and efficiency of the power protector circuit in charging high capacitance loads while ensuring robust protection against thermal overload and device damage.

While FIG. 6 illustrates a linear decrease in the temperature-adjusted elevated current limitation value 602 with respect to increasing temperature, it should be understood that this linear relationship is just one example and is not limiting. In other embodiments, the relationship between the temperature-adjusted elevated current limitation value 602 and temperature may follow different patterns or mathematical functions. For example, the decrease in the temperature-adjusted elevated current limitation value 602 may be non-linear, such as exponential, logarithmic, or stepped.

Additionally, the rate of change of the temperature-adjusted elevated current limitation value 602 with temperature may vary across different temperature ranges, depending on the specific thermal characteristics and requirements of the power protector circuit. The actual relationship between the temperature-adjusted elevated current limitation value 602 and temperature can be determined based on factors such as the device specifications, thermal design considerations, and application-specific requirements.

Further, in some embodiments, the temperature-adjusted elevated current limitation value 602 may be configurable or programmable, allowing for customization based on the specific needs of the system.

The temperature-dependent current control system described in this disclosure offers several advantages over known prior solutions for handling high current requirements during power-up sequences. The approach provides a more effective and efficient method for managing the charging of large external capacitors while considering the thermal limitations of the power protector circuit.

One advantage of the system is its ability to enable faster charging of external capacitors by dynamically adapting the current limit based on the system temperature. By allowing higher current limits at lower temperatures and gradually reducing the limit as the temperature increases, the system can optimize the charging process while ensuring safe operation within the thermal constraints of the device. This temperature-dependent adaptation can be particularly beneficial for integrated circuits (ICs) with limited thermal dissipation capability, such as those implemented using Bipolar-CMOS-DMOS (BCD) technology.

The proposed system offers significant improvements over existing solutions by avoiding unnecessary shutdowns of the power protector during the power-up sequence, except in cases of a short-to-ground fault. By dynamically adjusting the current limit based on the system temperature, the power protector can continue operating safely and efficiently, minimizing interruptions and enhancing overall system reliability.

The specific technical features that contribute to these advantages include the implementation of a temperature-sensing mechanism within the power protector circuit, which enables real-time monitoring of the system temperature. Additionally, the system can incorporate a control mechanism that dynamically adjusts the current limit based on the measured temperature, allowing for optimal charging performance while maintaining thermal stability.

A first aspect relates to a method for controlling current in a power protector circuit that protects a power channel supplying power to an external circuit, the method comprising activating an enhanced current handling mode for the power protector circuit during a power-up operation, the power protector circuit having a current limitation mode with a first current limit during regular operation, the enhanced current handling mode having a second current limit higher than the first current limit; ramping up an output current from zero to the second current limit over a first predetermined period; ramping down the output current from the second current limit to zero over a second predetermined period; and initiating an auto-retry mechanism allowing for multiple attempts to charge an external capacitance of the external circuit using the enhanced current handling mode, wherein each attempt includes the ramping up and ramping down.

In a first implementation form of the method, according to the first aspect as such, the method further comprising reducing the second current limit in response to an increase in a temperature of the power protector circuit.

In a second implementation form of the method, according to the first aspect as such or any preceding implementation form of the first aspect, the method further comprising asserting a dedicated input pin to enable the enhanced current handling mode.

In a third implementation form of the method, according to the first aspect as such or any preceding implementation form of the first aspect, the method further comprising latching off the power channel in response to determining that a maximum number of retry attempts has been reached to prevent further charging attempts until a fault condition is cleared or the power protector circuit is reset, wherein the latching is implemented using a hardware latch or a software flag.

In a fourth implementation form of the method, according to the first aspect as such or any preceding implementation form of the first aspect, a maximum number of retry attempts is configurable.

In a fifth implementation form of the method, according to the first aspect as such or any preceding implementation form of the first aspect, the method further comprising maintaining a retry counter to keep track of a number of attempted charging cycles.

In a sixth implementation form of the method, according to the first aspect as such or any preceding implementation form of the first aspect, the method further comprising entering a cool-down phase between each retry attempt to allow for thermal dissipation.

A second aspect relates to a power protector circuit for protecting a power channel supplying power to an external circuit, the power protector circuit comprising a power input terminal; at least one power output terminal; a current limiting circuit coupled between the power input terminal and the power output terminal, the current limiting circuit configured to operate in a current limitation mode with a first current limit during regular operation, and operate in an enhanced current handling mode with a second current limit higher than the first current limit during a power-up operation; and a control circuit configured to activate the enhanced current handling mode during the power-up operation, ramp up an output current from zero to the second current limit over a first predetermined period, ramp down the output current from the second current limit to zero over a second predetermined period, initiate an auto-retry mechanism that allows for multiple attempts to charge an external capacitance of the external circuit using the enhanced current handling mode, wherein each attempt includes the ramping up and ramping down, and latch off the power channel to prevent further charging attempts until a fault condition is cleared or the power protector circuit is reset in response to determining that a maximum number of retry attempts has been reached.

In a first implementation form of the power protector circuit, according to the second aspect as such, the power protector circuit further comprising a temperature sensing circuit configured to reduce the second current limit as a temperature of the power protector circuit increases.

In a second implementation form of the power protector circuit, according to the second aspect as such or any preceding implementation form of the second aspect, the power protector circuit further comprising a dedicated input pin for enabling the enhanced current handling mode; and a status register for indicating an operational state of the current limiting circuit.

In a third implementation form of the power protector circuit, according to the second aspect as such or any preceding implementation form of the second aspect, the control circuit is further configured to maintain a retry counter to keep track of a number of attempted charging cycles.

In a fourth implementation form of the power protector circuit, according to the second aspect as such or any preceding implementation form of the second aspect, the control circuit is further configured to enter a cool-down phase between each retry attempt to allow for thermal dissipation.

In a fifth implementation form of the power protector circuit, according to the second aspect as such or any preceding implementation form of the second aspect, the maximum number of retry attempts is configurable.

In a sixth implementation form of the power protector circuit, according to the second aspect as such or any preceding implementation form of the second aspect, the control circuit is further configured to latch off the power channel using a hardware latch or a software flag.

A third aspect relates to a system comprising an electronic control unit (ECU); a camera circuit; and a power protector circuit coupled between the ECU and the camera circuit for protecting a power channel supplying power to the camera circuit, the power protector circuit comprising a current limiting circuit configured to operate in a current limitation mode with a first current limit during regular operation and an enhanced current handling mode with a second current limit higher than the first current limit during a power-up operation; and a control circuit configured to activate the enhanced current handling mode during the power-up operation, ramp up an output current from zero to the second current limit over a first predetermined period, ramp down the output current from the second current limit to zero over a second predetermined period, initiate an auto-retry mechanism that allows for multiple attempts to charge a capacitance of the camera circuit using the enhanced current handling mode, and latch off the power channel to prevent further charging attempts until a fault condition is cleared or the power protector circuit is reset in response to determining that a maximum number of retry attempts has been reached.

In a first implementation form of the system, according to the third aspect as such, the camera circuit comprises an optical sensor, a radar sensor, a lidar sensor, an infrared sensor, an ultrasonic sensor, or a combination thereof.

In a second implementation form of the system, according to the third aspect as such or any preceding implementation form of the third aspect, the camera circuit comprises a serializer, a power management integrated circuit (PMIC), an image sensor, or a combination thereof.

In a third implementation form of the system, according to the third aspect as such or any preceding implementation form of the third aspect, the power protector circuit and the camera circuit are coupled through a coaxial cable for power delivery and data transmission.

In a fourth implementation form of the system, according to the third aspect as such or any preceding implementation form of the third aspect, the ECU is configured to monitor voltage and current conditions of the power protector circuit to detect a successful capacitance charging or a fault condition.

In a fifth implementation form of the system, according to the third aspect as such or any preceding implementation form of the third aspect, the power protector circuit further comprises a temperature sensing circuit configured to reduce the second current limit as a temperature of the power protector circuit increases.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A method for controlling current in a power protector circuit that protects a power channel supplying power to an external circuit, the method comprising:
activating an enhanced current handling mode for the power protector circuit during a power-up operation, the power protector circuit having a current limitation mode with a first current limit during regular operation, the enhanced current handling mode having a second current limit higher than the first current limit;
ramping up an output current from zero to the second current limit over a first predetermined period;
ramping down the output current from the second current limit to zero over a second predetermined period; and
initiating an auto-retry mechanism allowing for multiple attempts to charge an external capacitance of the external circuit using the enhanced current handling mode, wherein each attempt includes the ramping up and ramping down.

2. The method of claim 1, further comprising reducing the second current limit in response to an increase in a temperature of the power protector circuit.

3. The method of claim 1, further comprising asserting a dedicated input pin to enable the enhanced current handling mode.

4. The method of claim 1, further comprising latching off the power channel in response to determining that a maximum number of retry attempts has been reached to prevent further charging attempts until a fault condition is cleared or the power protector circuit is reset, wherein the latching is implemented using a hardware latch or a software flag.

5. The method of claim 1, wherein a maximum number of retry attempts is configurable.

6. The method of claim 1, further comprising maintaining a retry counter to keep track of a number of attempted charging cycles.

7. The method of claim 1, further comprising entering a cool-down phase between each retry attempt to allow for thermal dissipation.

8. A power protector circuit for protecting a power channel supplying power to an external circuit, the power protector circuit comprising:
a power input terminal;
at least one power output terminal;
a current limiting circuit coupled between the power input terminal and the power output terminal, the current limiting circuit configured to:
operate in a current limitation mode with a first current limit during regular operation, and
operate in an enhanced current handling mode with a second current limit higher than the first current limit during a power-up operation; and
a control circuit configured to:
activate the enhanced current handling mode during the power-up operation,
ramp up an output current from zero to the second current limit over a first predetermined period,
ramp down the output current from the second current limit to zero over a second predetermined period,
initiate an auto-retry mechanism that allows for multiple attempts to charge an external capacitance of the external circuit using the enhanced current handling mode, wherein each attempt includes the ramping up and ramping down, and
latch off the power channel to prevent further charging attempts until a fault condition is cleared or the power protector circuit is reset in response to determining that a maximum number of retry attempts has been reached.

9. The power protector circuit of claim 8, further comprising a temperature sensing circuit configured to reduce the second current limit as a temperature of the power protector circuit increases.

10. The power protector circuit of claim 8, further comprising:
a dedicated input pin for enabling the enhanced current handling mode; and
a status register for indicating an operational state of the current limiting circuit.

11. The power protector circuit of claim 8, wherein the control circuit is further configured to maintain a retry counter to keep track of a number of attempted charging cycles.

12. The power protector circuit of claim 8, wherein the control circuit is further configured to enter a cool-down phase between each retry attempt to allow for thermal dissipation.

13. The power protector circuit of claim 8, wherein the maximum number of retry attempts is configurable.

14. The power protector circuit of claim 8, wherein the control circuit is further configured to latch off the power channel using a hardware latch or a software flag.

15. A system comprising:
an electronic control unit (ECU);
a camera circuit; and
a power protector circuit coupled between the ECU and the camera circuit for protecting a power channel supplying power to the camera circuit, the power protector circuit comprising:
a current limiting circuit configured to operate in a current limitation mode with a first current limit during regular operation and an enhanced current handling mode with a second current limit higher than the first current limit during a power-up operation; and
a control circuit configured to:
activate the enhanced current handling mode during the power-up operation,
ramp up an output current from zero to the second current limit over a first predetermined period,
ramp down the output current from the second current limit to zero over a second predetermined period,
initiate an auto-retry mechanism that allows for multiple attempts to charge a capacitance of the camera circuit using the enhanced current handling mode, and
latch off the power channel to prevent further charging attempts until a fault condition is cleared or the power protector circuit is reset in response to determining that a maximum number of retry attempts has been reached.

16. The system of claim 15, wherein the camera circuit comprises an optical sensor, a radar sensor, a lidar sensor, an infrared sensor, an ultrasonic sensor, or a combination thereof.

17. The system of claim 15, wherein the camera circuit comprises a serializer, a power management integrated circuit (PMIC), an image sensor, or a combination thereof.

18. The system of claim 15, wherein the power protector circuit and the camera circuit are coupled through a coaxial cable for power delivery and data transmission.

19. The system of claim 15, wherein the ECU is configured to monitor voltage and current conditions of the power protector circuit to detect a successful capacitance charging or a fault condition.

20. The system of claim 15, wherein the power protector circuit further comprises a temperature sensing circuit configured to reduce the second current limit as a temperature of the power protector circuit increases.
